(19) United States
(12) Patent Application Publication
(10) Pub. No.: US 2026/0334478 A1
(43) Pub. Date: Oct. 29, 2026

(54) Conveyor Tunnel Oven

(71) Applicant: Wolfe Electric, Inc., Wichita, KS (US)

(72) Inventor: Ronald D. Wolfe, Wichita, KS (US)

(73) Assignee: Wolfe Electric, Inc., Wichita, KS (US)

(21) Appl. No.: 19/696,682

(22) Filed: Jun. 3, 2026

(51) Int. Cl. A21B 3/00; A21B 1/48

(52) U.S. Cl. CPC A21B 3/00; A21B 1/48

(57) ABSTRACT

A conveyor tunnel oven incorporating a baking case having a rear wall, an upper wall, a lower wall, and having longitudinal and oppositely longitudinal ends; the oven further incorporating longitudinal and oppositely longitudinal “C” walls mounted at the case’s ends, wherein each “C” wall has upper and lower arms, a bar between the arms’ proximal ends, and a forwardly opening throat; the oven further incorporating a food conveyor spanning longitudinally between the “C” walls’ throats; the oven further incorporating longitudinal and oppositely longitudinal “C” braces, wherein each “C” brace has an upper arm, a lower arm, and a vertical bar, wherein the longitudinal and oppositely longitudinal “C” braces are fixedly attached to the longitudinal and oppositely longitudinal “C” walls.

### FIELD OF THE INVENTION

The instant invention relates to conveyor tunnel ovens of the type which incorporate a baking case having longitudinal and oppositely longitudinal ends, wherein the base baking case is opened by food passage ports within such ends. Such conveyor tunnel ovens commonly include continuous loop grate type food conveyors which span between the food passage ports, such conveyors extending longitudinally through their baking cases. Such conveyor tunnel ovens also commonly incorporate finger duct air registers above and below food conveyors for directing blower driven cooking air downwardly and upwardly against food items conveyed through the baking case.

### BACKGROUND OF THE INVENTION

Stackable conveyor tunnel ovens commonly incorporate removable front wall panels which provide access to the front ends of the baking cases. The removable character of such front wall panels commonly make them unsuitable for service as baking case structural support members.

To prevent flexible downward deflections of the upper walls or ceilings of such baking cases upon removal of their front wall panels, rigid vertical supports are commonly provided at the baking cases’ front ends. Such front end supports commonly extend vertically between a case's floor or lower wall and the case's upper wall or ceiling, such vertical supports being typically positioned forwardly from the forward ends of the case’s food passage ports.

Conventional installation and use of such front-end vertical supports within a baking case beneficially resists downward deflection and deformation of the baking case's ceiling upon removal of the case’s front wall panels. However, such front-end vertical supports undesirably interfere with frontward and rearward de-installations and installations of the oven’s food conveyor. While a removal of such oven’s front end vertical supports may facilitate rearwardly and forwardly directed installations and de-installations of the food conveyor, such removal of support typically creates an unacceptable risk of a weight induced downward deflection of the baking case's upper wall.

The instant inventive conveyor tunnel oven solves or ameliorates the problems, drawbacks, and deficiencies of prior art conveyor tunnel ovens, as described above, by providing specialized braces at the baking case’s longitudinal and oppositely longitudinal walls, such braces preventing downward deflections of the case’s ceiling while enabling forwardly and rearwardly directed installations and de-installations of the oven’s conveyor.

### BRIEF SUMMARY OF THE INVENTION

The instant inventive conveyor tunnel oven comprises a baking case which incorporates a rear wall, an upper wall or ceiling, and a lower wall or floor. The baking case has longitudinal and oppositely longitudinal ends which are preferably partially covered or closed by fixedly attached longitudinal and oppositely longitudinal “C” configured walls. Each of the baking case’s “C” walls preferably comprises upper arm, a lower arm, and, similarly with a typographic capital letter “C”, a bar which spans vertically between and interconnects the proximal ends such arms. The inventive oven’s longitudinal and oppositely longitudinal “C” walls form forwardly opening throats which function as longitudinal and oppositely longitudinal food passage ports.

The instant invention’s longitudinal and oppositely longitudinal “C” walls purposefully omit any support members which span vertically between distal ends of their cantilevering upper and lower arms. While conventional conveyor tunnel oven baking cases typically include internal components, such as air register ducts, which may be installed or deinstalled through the case’s forward opening, such conventional ovens typically mechanically prohibit rearward and forward installations and deinstallations of their continuous loop food conveyors. Such baking cases typically include vertical supports at the forward ends of their food passage ports, and such supports mechanically block any rearward or forward passage of the food conveyor into or out of the baking case. The presence of such vertical supports at the forward ends of such conventional oven’s food passage ports requires that installations and deinstallations of the oven’s longitudinally oblongated conveyors pass either longitudinally or oppositely longitudinally through one of the oven’s food passage ports. However, such longitudinal passage of the conveyor is often impossible or impractical.

A continuous loop food conveyor component of a conventional tunnel oven commonly has a 3’ 8” lateral or front-to-rear dimension and a 7’ 9” longitudinal dimension. Workspaces within commercial kitchens where such conveyor tunnel ovens operate commonly provide a work area in front of the oven having a lateral dimension in excess of the conveyor’s common 3’ 8” lateral width. In contrast, work areas at the longitudinal ends of such ovens commonly have longitudinal dimensions which are markedly less than such common 7’ 9” food conveyor length. While such kitchens commonly include workspaces which would facilitate a laterally directed deinstallation or installation of a conventional oven’s food conveyor, such oven’s end wall vertical supports often mechanically prohibit such frontward / rearward direction of deinstallation and installation. Wall structures or other restaurant equipment located near the longitudinal ends of such oven may similarly mechanically block any longitudinally directed deinstallation or installation of the oven’s food conveyor.

Where both directions of food conveyor installation / deinstallation are blocked, as described above, operators or oven maintenance workers may be required to inconveniently reposition the conventional oven in order to longitudinally pass the food conveyor through one of the oven’s food passage ports. The instant invention’s omission of vertical end wall supports at the forward ends of the oven’s food passage ports are intended to assure that the oven’s longitudinally obligated food conveyor may be forwardly installed or deinstalled, obviating inconvenient repositioning the oven. However, a simple modification of the end walls of a commercial conveyor tunnel oven’s end walls to include a “C” configuration (via removals of front-end vertical supports) may render the oven inoperable.

Commercial conveyor tunnel ovens are commonly stacked, one upon another. Accordingly, the vertical end wall supports which are commonly installed at the front ends of a conventional conveyor tunnel oven’s food passage ports may support both the weight of that oven’s ceiling and the weight of as many as two overlying tunnel ovens. In absence of such front-end vertical supports, the oven’s upper wall may deflect downwardly under the weight of overlying stacked ovens. Such downward upper wall deflection may disarrange the oven’s front panel mounting points, making it mechanically impossible to re-install the oven’s front panel. Accordingly, a simple removal of the front-end vertical supports from the longitudinal end walls of a conventional conveyor tunnel oven may render the oven inoperable.

To accommodate for such downward ceiling deflections while facilitating frontward / rearward passages of the food conveyor, the instant inventive tunnel oven attaches longitudinal and oppositely longitudinal “C” braces to the oven’s “C” configured end walls. Similarly with the oven’s “C” walls, the braces have upper and lower arms, and have vertical bars which span between and interconnect proximal ends of the “C” braces’ upper and lower arms. Just as the typographic components of a capital letter “C” include upper and lower arms extending from upper and lower ends of the letter’s vertical bar or column, the instant invention’s “C” braces include rearward vertical bars which span vertically between proximal ends of the “C” braces’ upper and lower arms.

In a suitable embodiment, the instant invention’s end wall braces constitute rigid and wholly formed steel plates which mirror the end walls’ “C” configurations. To avoid any externally obtrusive mounts of such “C” braces at the longitudinal and oppositely longitudinal ends of the oven, and to avoid internal baking space wasting mounts of such “C” braces upon the inner surface of the oven’s end walls, such “C” braces may be mounted within interior spaces defined by the thickness dimensions of the oven’s end walls. Such oven end walls commonly comprise internal and external skin layers of sheet steel which interstitially enclose a body of glass fiber insulation material. Interior spaces which are normally filled with insulation material may advantageously receive the invention’s “C” configured brace plates.

Installations of the suitably provided longitudinal and oppositely longitudinal steel plate configured “C” braces within the oven’s longitudinal and oppositely longitudinal “C” configured walls structurally reinforce the walls’ upper end lower arms, advantageously resisting any weight induced downward deflection of the oven’s ceiling. The interior wall space mounting locations of such “C” braces further advantageously avoids waste of interior baking case space and avoids a visually obtrusive and unsightly presentation of ”C” braces at the exteriors of the oven’s end walls.

Notwithstanding the above-described advantages of end wall installations of ceiling supporting “C” braces, configuration of the braces as solid rigid plates is not preferred. A rigid plate configuration of the “C” braces may add excessive weight to the oven, and the rigid character of such plates may undesirably eliminate any possibility of future adjustment of the angular orientations of the oven’s end walls and ceiling.

Instead of the above-described rigid and wholly formed configuration of the oven’s longitudinal and oppositely longitudinal “C” braces, the arms of the instant invention’s “C” braces are preferably pivotally mounted, and mechanical means for selectively pivoting such arms are preferably provided. While pivoting adjustments of vertical displacements of the distal ends of the “C” braces’ arms may be achieved upon pivotally mounting only one of the each of a brace’s arms, a preferred embodiment pivotally mounts each of the “C” braces’ forwardly cantilevering arms. The proximal end of each “C” brace upper arm is preferably joined by a hinge with the upper end of a “C” brace bar component, the proximal end of each “C” brace lower arm being mirroringly joined by another hinge with the lower end of a “C” brace’s bar.

Since a primary function of the invention’s “C” brace components is countering the tendency of overlying stacked ovens to downwardly deflect the ceiling of an underlying oven, the invention’s means for vertically adjusting the vertical displacements of the “C” walls’ distal ends are primarily used to increase such vertical displacements, effectively widening the forward mouth openings of the throats of both the “C” walls and their internally mounted “C” braces. Notwithstanding, a mechanical ability to widen such mouth openings introduces a possibility of excess widening. Accordingly, the invention’s means for adjusting the vertical displacements of the distal ends of the “C” braces’ (and of the “C” walls’) upper and lower arms are preferably additionally capable of alternatively narrowing such mouth openings.

In a preferred embodiment, the provided means for adjusting the vertical displacements of the distal ends of the “C” braces’ arms comprise mechanical linear motion actuators. Each provided linear motion actuator preferably has a proximal and a distal end, with each proximal end being attached to one of the “C” braces’ rearward vertical bars and with each distal end being attached to one of the “C” braces’ arms. In a preferred mode of mounting, each linear motion actuator completes a triangular bar linkage whose other bars comprise an upper or lower portion of one of the “C” braces’ vertical bars and a proximal portion of one of the “C” braces’ arms. Such arm and vertical bar components of the triangular bar linkages preferably have fixed lengths, while the linear motion actuator segments of the triangular linkages are mechanically capable of alternatively increasing and decreasing their lengths.

Upon extending operations of such preferably provided linear motion actuators, the angles between such triangular linkages’ arm and bar components are increased, effectively vertically splaying such arms away from each other. Accordingly, such linear motion actuator extension may increase the vertical displacement of the “C” braces’ arms (and their attached “C” wall arms), advantageously reversing an undesirable weight induced downward deflection of the oven’s ceiling. An opposite operation of the linear motion actuator may reduce the vertical distance between such arms’ distal ends, reversing any excess widening of the “C” walls’ forward mouth openings.

The linear motion actuator components of the instant invention’s means for vertically widening the “C” braces’ throats may suitably comprise hydraulic cylinders, pneumatic cylinders, motor driver ball screw actuators or motor driven rack and pinion gear actuators. However, in the preferred embodiment, the provided linear motion actuator components incorporate rigid shafts having a pivot mounts at their distal ends, and having a circular cam receiving bearings at their proximal ends. Circular cams are rotatably mounted within such bearings, each cam having a rotation axis which is displaced radially from its geometric center. Each rotatable cam is mounted via an axle to the “C” braces’ rearward bar, such axle restricting motion of the cam to rotation about its off-center rotary axis.

Powered rotations of the preferred linear motion actuators’ cams may drive their excentric ends (i.e. the ends of the cams which extend radially oppositely from their rotation axes) forwardly or toward the actuators’ distal ends, effectively increasing the actuators’ lengths to vertically splay the “C” braces’ arms. Powered rotations of such cams’ excentric ends away from the actuators’ distal ends may shorten the actuators, oppositely contracting the “C” braces’ arms.

Operation of the preferably provided circular cam components of the invention’s arm splaying means requires the provision of a separate or additional mechanism which applies rotary torque to the cams. In a suitable embodiment, gear trains which include manually turned or motor turned drive gears, and include driven gears which are attached to the circular cams may suitably be provided. However, in the preferred embodiment, the circular cams are rotated by attached levers whose fulcrums coincide with the cams’ axles and rotation axes.

Provided that the lever components of the linear motion actuators have sufficient lengths, they may be turned manually. However, further mechanisms which move the levers’ levering ends orbitally about their fulcrums/rotation axes are preferably provided. In the preferred embodiment, such lever actuating mechanisms comprise jack screws which include fixed and rotatable screw shafts whose threads carry an internally helically threaded nut. Attachments of the levering ends of the levers to such threaded nuts allow powered rotations and counterrotations of the screw shaft to orbitally turn and counter-turn the levers, causing their levered ends to turn and counter turn the cams.

Similarly with the preferred mounts of the “C” brace components within the interior insulation housing spaces of the oven’s end walls, the preferably provided lever and jack screw mechanisms may be unobtrusively mounted within such wall spaces. Such interior wall mounts allow drive shafts extending from the jack screws to extend rearwardly to the oven’s rear end. Turning means such as hexagonal heads formed at such drive shafts’ rearward ends may be exposed at the back side of the oven.

In operation of the instant inventive conveyor tunnel oven, and assuming provisions of preferred components and mechanisms as described above, an oven operator attempting to re-install one of the ovens’ front wall panels may have difficulty doing so. Upon diagnosing the problem as a vertical misalignment of the panel’s and oven’s front panel screw mount apertures, the operator may apply a socket wrench to the hexagonal heads which are exposed at the oven’s back side.

Socket wrench actuated turning or counterturning of such hexagonal heads turns or counter-turns the jackscrews’ screw components, resulting in rearward or forward movement of the helically threaded nuts along the screws. Such rearward or forward movements of the nuts in turn orbitally move the levers’ levering ends rearwardly or forwardly, rotating the circular cams which are attached to the levers’ levered ends. Accordingly, such turning or counter turning of hexagonal heads at the back of the oven may alternatively extend the excentric ends of the linear motion actuators’ cams toward or away from such actuators’ distal ends, alternatively lengthening or shortening the actuators.

The hexagonal shaft head turn actuated lengthenings and shortenings of the ovens’ linear motion actuators in turn pivot or counter-pivot the “C” braces’ arms so that their distal ends move toward or away from each other. The in-wall mounts of the actuator adapted “C” braces operatively translate the splaying or contracting motions of the “C” braces’ arms into concurrent splaying or contacting motions of the “C” walls’ arms, and of the oven’s ceiling which is supported by such walls.

Where, for example, the operator finds that the vertical spacings of the oven’s front panel mounting apertures are 1/16 inches less than the vertical spacings of the panel’s mounting apertures, the operator may utilize the socket wrench to impose a 90-degree turn upon each of the oven’s rear hexagonal shaft heads. Such wrench actuated turns may advantageously splay the “C” walls arms 1/16 inch to precisely align the ovens’ panel mounting aperture with those of the oven’s front panel.

Accordingly, objects of the instant inventive conveyor tunnel oven include the incorporation of structures as described above, and include arrangements of those structures in manners described above for the performance of beneficial functions as described above.

Other and further objects, benefits, and advantages of the instant invention will become known to those skilled in the art upon review of the detailed description which follows, and upon review of the appended drawings.

### BRIEF DESCRIPTION OF DRAWINGS

FIG. 1 is a perspective view of the instant inventive conveyor tunnel oven, the view showing three renditions of such oven stacked vertically.

FIG. 2 re-depicts the structure of FIG. 1, the view of FIG. 2 showing front wall panels removed.

FIG. 3 is a longitudinal end view of the stacked conveyor tunnel ovens of FIG. 2.

FIG. 4 is a magnified view of a portion of the structure of FIG. 3, the view of FIG. 4 including a cutaway section showing internal structures, and including dashed lines indicating a removal of a control box component.

FIG. 5 is a perspective view of a rigid “C” brace component shown in FIG. 4, the view of FIG. 5 showing such component removed.

FIG. 6 presents an alternate configuration of the structure of FIG. 5.

FIG. 7 presents an alternate configuration of the structure of FIG. 4.

FIG. 8 is a magnified view of a portion of the structure of FIG. 7, as indicated in FIG. 7.

FIG. 9 shows an alternate configuration of the structures of FIG. 8.

FIG. 10 is a rear view of the conveyor tunnel oven of FIG. 7.

### DETAILED DESCRIPTION OF THE INVENTION

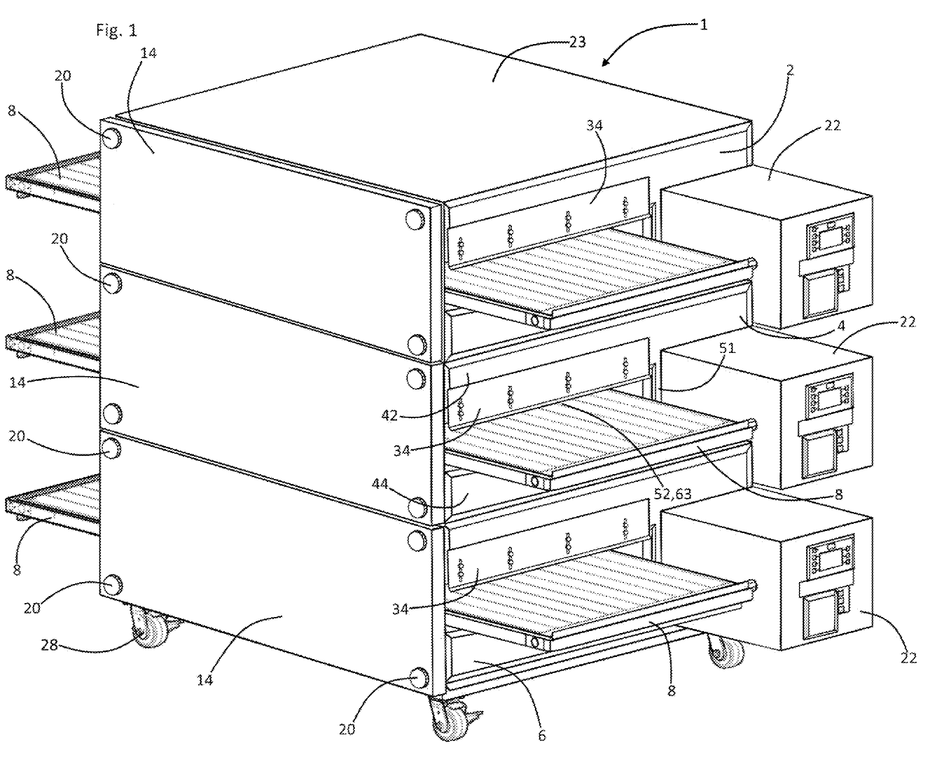

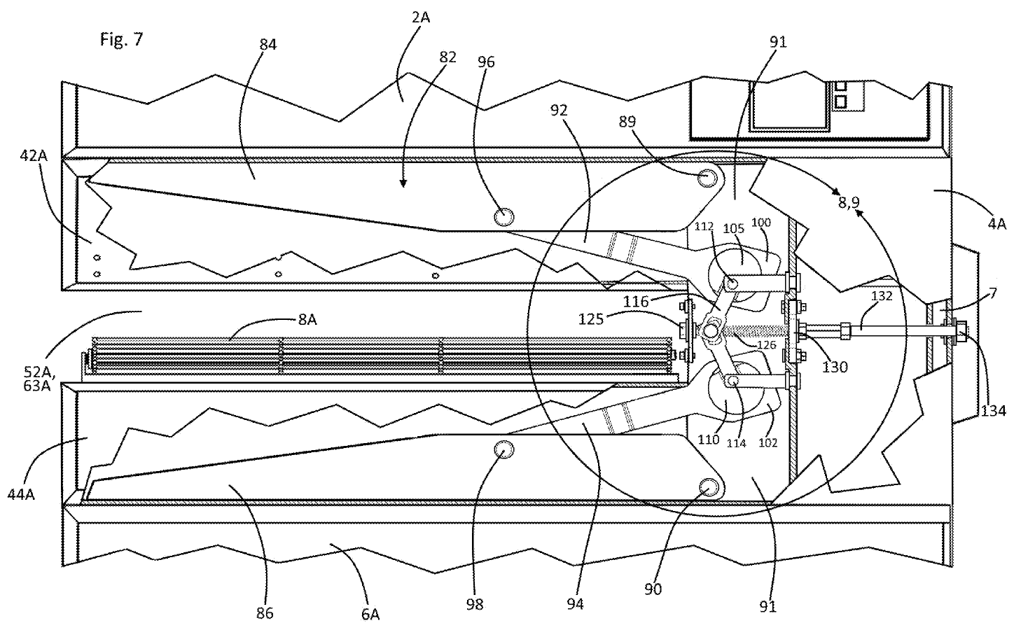

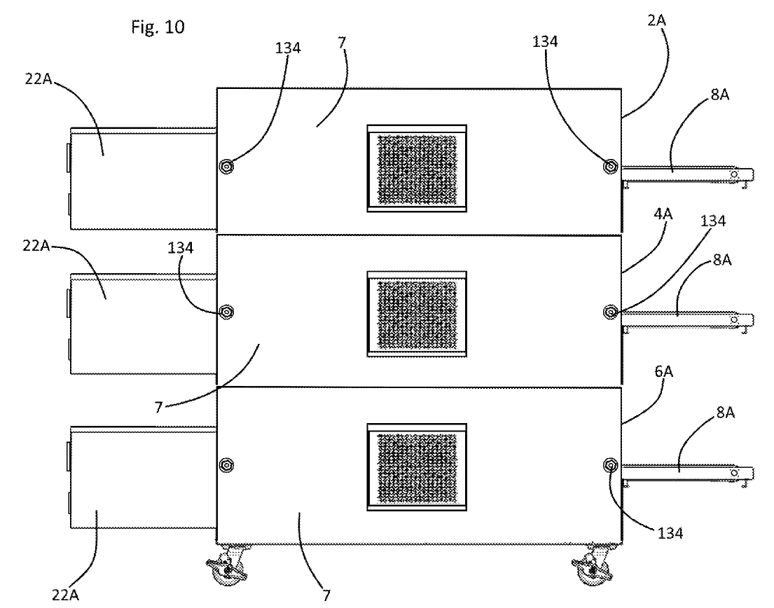

Referring to FIGS. 1-5, a suitable embodiment of the instant inventive conveyor tunnel oven is referred to generally by reference arrow 1. As shown in FIG. 1, a triple stack of the instant inventive conveyor tunnel ovens is depicted, such oven stack consisting of an upper oven 2, a middle oven 4, and a lower oven 6. Each of the ovens has an upper wall or ceiling 23, and a lower wall or floor 19. As indicated in the alternate configuration of FIGS. 7 and 10, each of the ovens has a rear wall 7. The front walls of the ovens 2, 4, and 6 take the form of removable panels 4, such panels being attached by knob headed screws 20 which engage screw sockets 21.

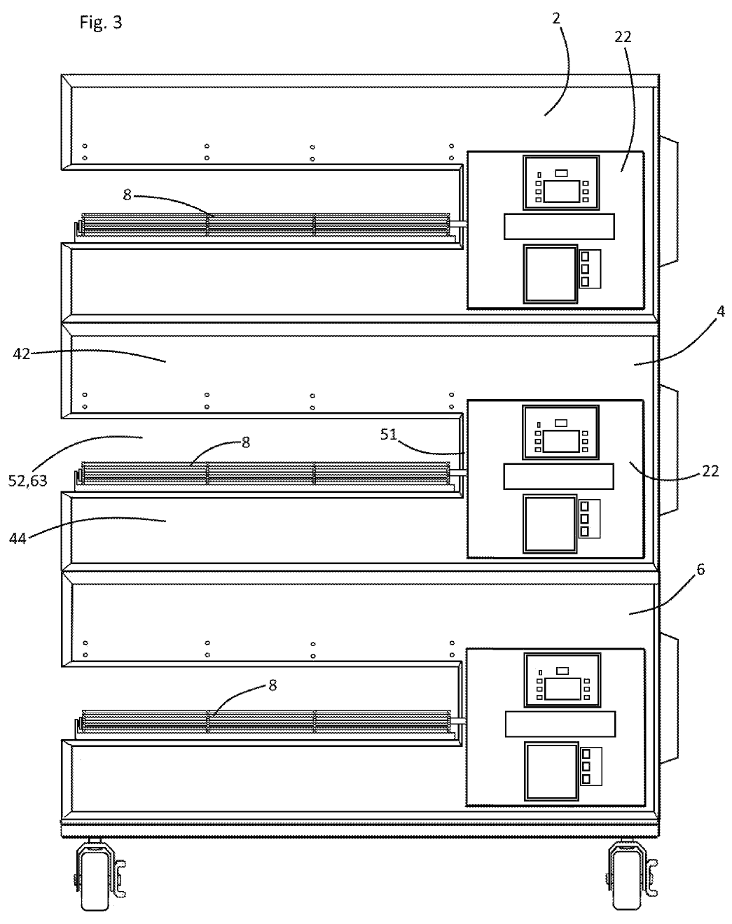

The longitudinal and oppositely longitudinal ends of the baking cases 2, 4, and 6 are supported by and are partially closed by “C” walls. For example, as shown in FIG. 3, the longitudinal “C” configured wall of the oven stack’s middle oven 4 comprises a cantilevering upper arm 42 and a cantilevering lower arm 44. The proximal or rearward ends of such arms are supported and interconnected by a vertically extending end wall component 51. Similarly with the components of a capital letter “C” which includes upper and lower arms and an interconnecting vertical bar, such end wall component 51 is denominated a vertical bar. Control cases 22 are mounted to the end walls of the ovens 2, 4, and 6, such cases housing oven electronics, a conveyor motor and burner components.

An operator’s removal of the ovens’ front panels 14 provides frontward access to interior upper and lower air register finger ducts 30 and 32. Such panel removal also provides frontward access to the ovens’ grate type continuous loop food conveyors 8 which extend longitudinally through the baking cases. While such front panel removals provide easy access to the baking cases’ interior components, the front panel removals eliminate frontward structural support which would otherwise be provided by the front panels at the baking cases’ forward ends. For example, the elimination of the middle oven’s front panel support may undesirably allow the forward end of such oven’s ceiling to sag or deflect downwardly, such deflection being driven by the weight of the overlying baking case 2. A direct undesirable consequence of such weight induced ceiling deflection may be a distortion of the rectangular pattern of the baking case’s front panel mounting screw sockets 21, such pattern distortion preventing any re-installation of the front panel 14.

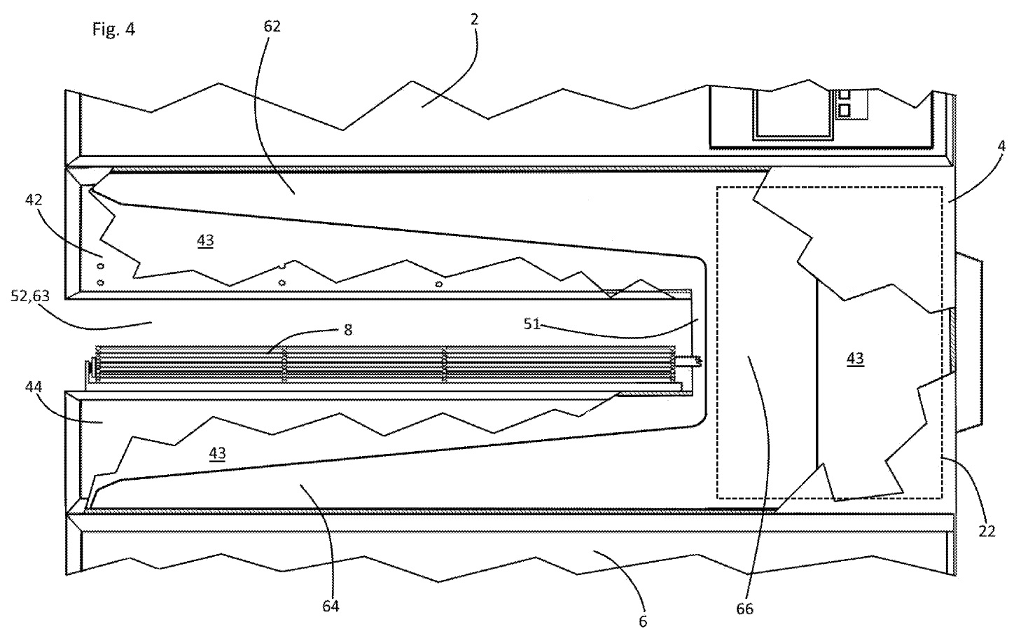

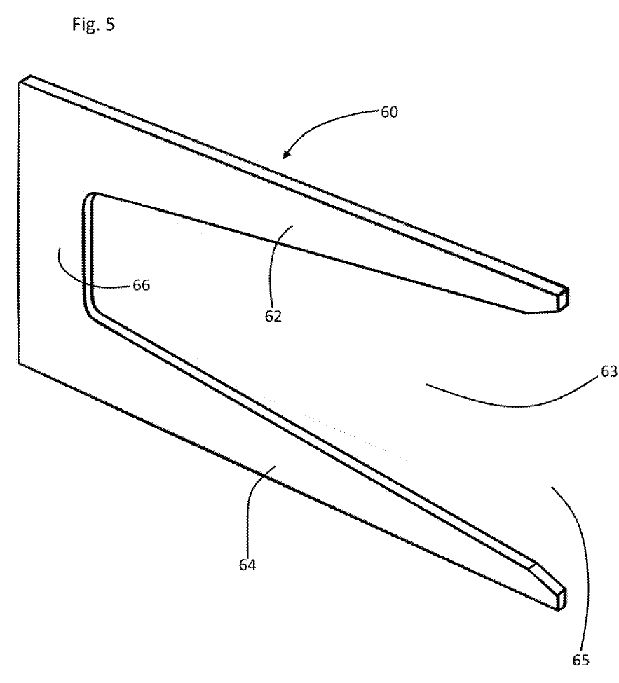

Referring in particular to FIGS. 4 and 5, “C” brace components 60 may be mounted upon or within each of the baking case’s “C” configured longitudinal and oppositely longitudinal end walls. Similarly with such walls’ “C” configurations, the ovens’ “C” brace components 60 present upper arms 62 and lower arms 64, such arms having proximal ends which are interconnected by rearward or proximal vertical bar components 66. The “C” braces 60 form throat spaces 63 through which the food conveyors 8 pass, such throats 63 forming forward openings 65 which coincide with the “C” walls’ forward openings. The inventive oven’s “C” wall and “C” brace combinations facilitate dual modes of conveyor passage, their throat portions allowing longitudinal conveyor passages, and their laterally opening mouths allowing lateral conveyor passages.

The “C” braces 60 are preferably mounted and installed within interior spaces or matrices of the oven's longitudinal and oppositely longitudinal “C” configured walls. Suitably, though less desirably, the “C” brace components may be fixedly mounted at interior or exterior surfaces of such walls.

In operation, the “C” braces 60 lend structural rigidity to both the ovens’ longitudinal and oppositely end walls and the ovens’ upper walls or ceilings, the brace enhanced structural rigidity resisting downward deflections of the “C” walls’ upper arms and resisting downward deflection of the ceilings which are supported by such walls.

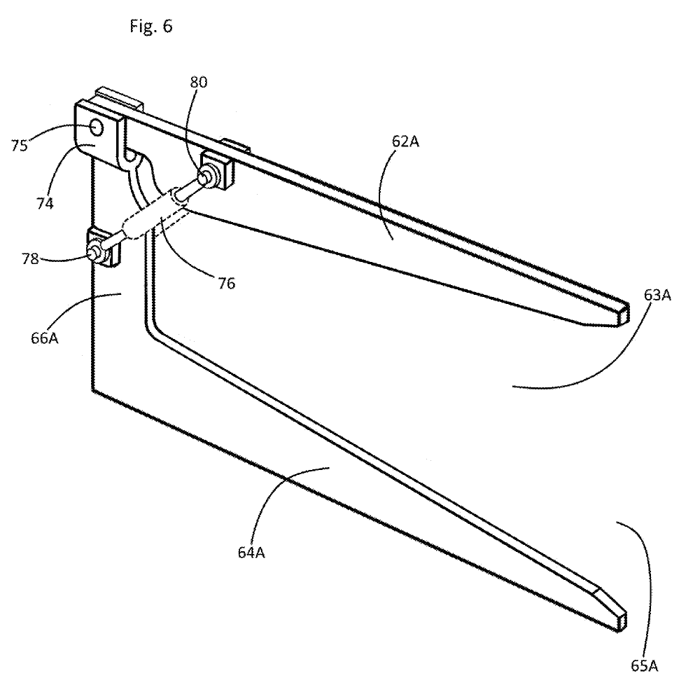

Referring to the alternatively configured “C” brace 68 appearing in FIG. 6, structures identified by a reference numeral having a suffix “A” are configured similarly with similarly numbered structures appearing in FIGS. 4 and 5. In the FIG. 6 configuration, the “C” brace's upper arm 62A has its proximal end pivotally attached to the upper end of vertical bar 66A by a clevis and pin hinge combination 74,75. A triangulating linear motion actuator 76 spans between the cantilevering upper arm 62A and the bar 66A. Such actuator 76 has a proximal or rearward end which is pivotally mounted upon the bar 66A and has a distal or forward pivot mount 80 near the proximal end of the upper arm 62A.

The dashed line portions of the linear actuator 76 are intended as being representative of various types of linear motion actuators including jack screw actuators, rotatable cam actuators, rack and pinion gear actuators, pneumatic actuators, hydraulic actuators, and the like.

In operation of the alternatively configured “C” brace of FIG. 6, downward deflection of the upper arm 62A resulting from overlying loading (such as the weight of an overlying stacked oven) may be counteracted via operation of the linear motion actuator 73.

Referring to the further alternate configuration of FIG. 7, all structures identified by a reference numeral having a suffix “A” are configured similarly with similarly numbered structures appearing in other figures. FIG. 7’s alternatively configured “C” brace, designated by reference arrow 82, has an upper arm 84, a lower arm 86, and a vertically extending rear bar 91. The proximal or rearward end of the upper arm 84 is pivotally mounted upon the upper end of the bar 91 by a hinge 89, and the vertically mirroring proximal end of the “C” brace’s lower arm 86 is mounted to the lower end of the bar 91 by a hinge 90. Triangulating linear motion actuators 92 and 94 respectively span between the bar 91 and the upper and lower arms 84 and 86, such linear motion actuators respectively having distal or forward pivot mounts 96 and 98.

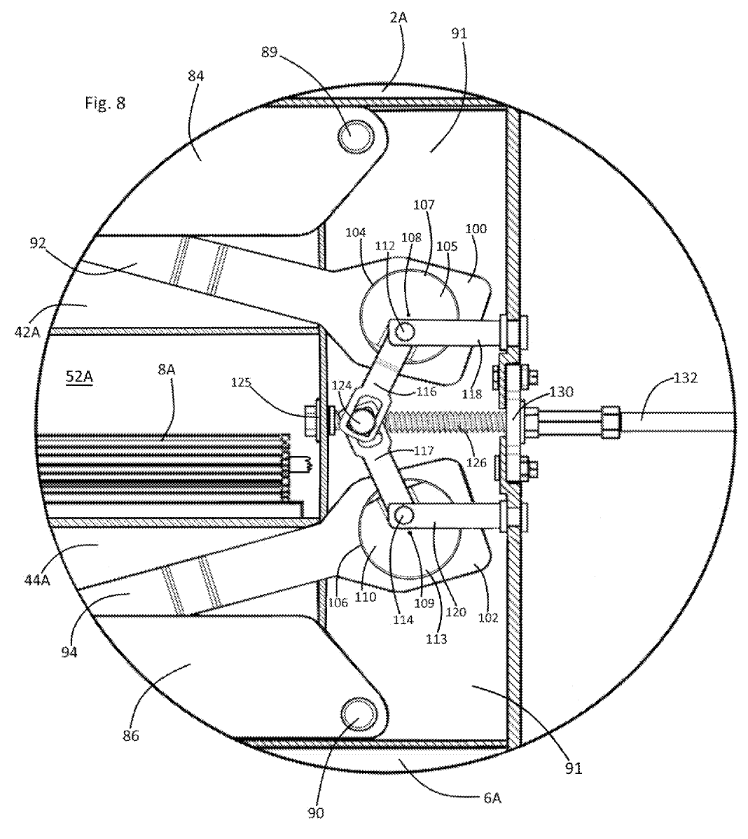

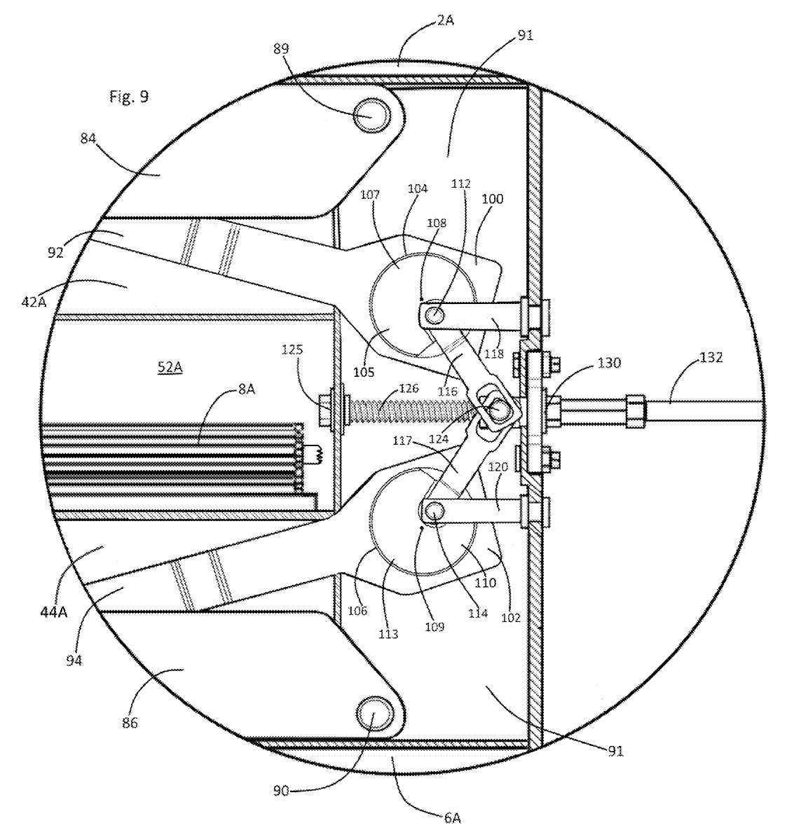

Referring further to FIGS. 8 and 9, the rearward ends 100 and 102 of the linear motion actuators 92 and 94 preferably incorporate circular cams 105 and 110, such cams being rotatably received within circular bearings 104 and 106 formed within the actuators’ proximal ends. The cams 105 and 110 respectively rotate about fixed rotation axes and axles 112 and 114. Such rotation axes are displaced radially away from the geometric centers 108 and 109 of the cams 105 and 110, such rotation axis displacements respectively establishing eccentric cam ends 107 and 113.

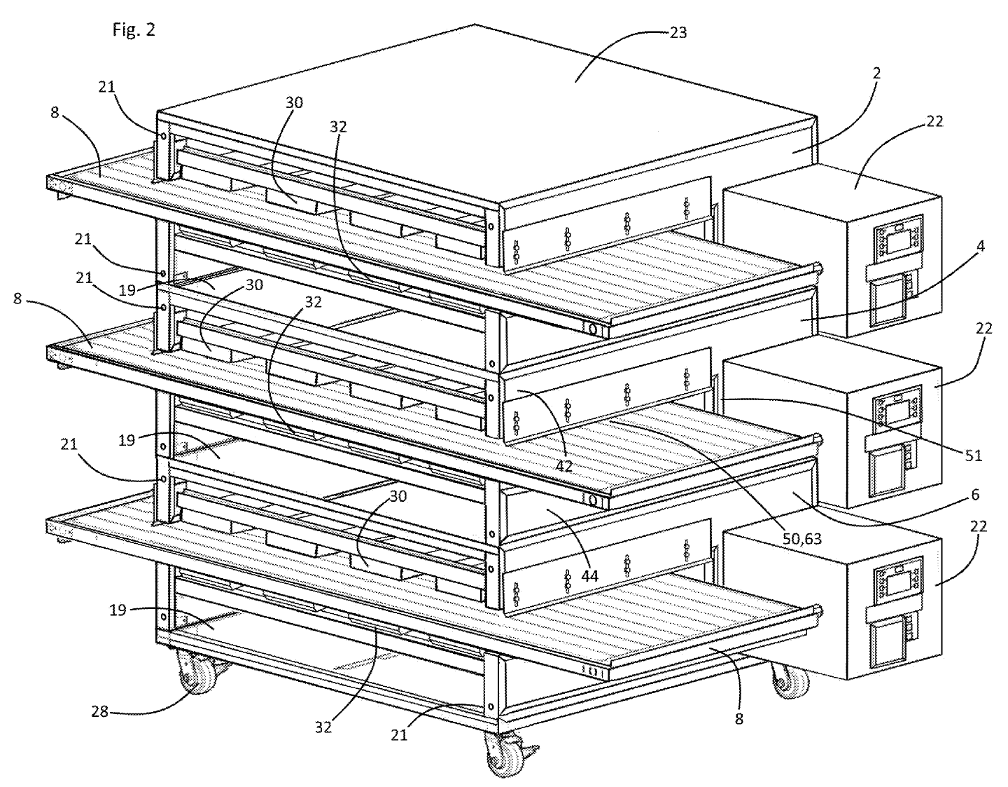

Referring in particular to FIG. 9, respective counterclockwise and clockwise rotations of cams 105 and 110 about their rotation axes 112 and 114 to their depicted positions wherein their eccentric ends 107 and 113 extend forwardly effectively lengthen the linear motion actuators 92 and 94. Such cam rotation lengthening of actuators 92 and 94 operatively pivot and counter pivot the “C” brace’s upper and lower arms 84 and 86 in clockwise and counterclockwise directions. Such arm pivoting motions vertically widen both the “C” brace’s throat 63A and the “C” wall’s throat 52A. Such cam actuated throat widening may advantageously reverse an undesirable downward deflection of “C” arms 42A resulting from the weight of the overlying oven 2A. Referring simultaneously to FIGS. 1 and 2, such weight induced downward deflection may distort the pattern of front panel mounting sockets 21, interfering with installation of the front panel 14. The “C” arm splaying function of the rotations of cams 105 and 110 may advantageously restore the rectangular pattern of mounting sockets 21, permitting reinstallation of front panel 14.

To achieve the above-described cam actuated extending and retracting motions of the linear motion actuators 92 and 94, levers 116 and 117 are preferably provided, such levers having levered ends rigidly and fixedly attached to the cams 105 and 110. The levers 116 and 117 function in relation to the cams 105 and 110 in the manner of a crank which may forcefully rotate the cams 105 and 110 about their rotation axes 112 and 114. The axles and rotation axes 112 and 114 further function in relation to the levers 116 and 117 as fulcrums. To restrict the motion of the fulcrums / axles 112 and 114, and their attached components, to rotation about their longitudinal rotation axes, their longitudinal and oppositely longitudinal ends are suitably anchored in a double shear fashion, with the oppositely longitudinal ends of the axles 112 and 114 being supported by bars 91 and with such axles’ longitudinal ends being supported by braces 118 and 120.

The opposite levering ends of the levers 116 and 117 are preferably actuated and orbitally turned by a jack screw 124,126. A rearward end of the jack screw 124,126 is preferably supported by a rotary mount 130, and a forward end is supported by a rotary mount 125. The external helical threads of the jackscrew are received within an internally helically threaded coupler or nut 124 which travels forwardly and rearwardly along the jackscrew actuator. Turning means, suitably in the form of rearwardly extending drive shafts 132 having hexagonally configured shaft heads 134, are preferably provided, such turning means being mounted and situated at or within the baking case's rear wall 7.

In use of the instant inventive assembly represented by FIGS. 7-10, an operator may apply a socket wrench to hexagonal heads 134 to turn such heads clockwise. Such clockwise turning actuates the screw shaft 126,132 to draw the jackscrew’s helically threaded nut 124 rearwardly from the FIG. 8 position to the FIG. 9 position. Such rearward travel of the nut 124 carries the levering ends of the levers 116 and 117 rearwardly, such levering motions such turning their levered ends against their attached circular cams 105 and 110, thereby rotating the cams from their FIG. 8 positions to their FIG. 9 positions.

Upon rotations of the cams 105 and 110 to their FIG. 9 positions, their eccentric ends 107 and 113 are forcefully extended forwardly, increasing the effective lengths of the upper and lower linear motion actuators 92 and 94. Accordingly, the operator's socket wrench actuated turning of hexagonal heads 34 operatively splays the “C” braces upper and lower arms 84 and 86, correspondingly operatively splaying the “C” walls upper and lower arms 42A and 44A. The above-described socket wrench turns of hexagonal heads 134 may selectively splay the cantilevering arms of the ovens’ “C” configured end walls, advantageously countering and correcting any downward deflection of such walls. Counterclockwise turning of the hexagonal heads 134 may contract the oven’s “C” arms.

While the principles of the invention have been made clear in the above illustrative embodiment, those skilled in the art may make modifications to the structure, arrangement, portions, components, and method steps of the invention without departing from those principles. Accordingly, it is intended that the description and drawings be interpreted as illustrative and not in the limiting sense, and that the invention be given a scope commensurate with the appended claims.

1. A conveyor tunnel oven comprising:
1a. a baking case comprising a rear wall, an upper wall, a lower wall, a longitudinal end, and an oppositely longitudinal end;
1b. longitudinal and oppositely longitudinal “C” walls respectively fixedly mounted at the baking case’s longitudinal and oppositely longitudinal ends, each “C” wall having an upper arm, a lower arm, a bar spanning vertically between proximal ends of said arms, and a forwardly opening throat;
1c. a food conveyor spanning longitudinally between the “C” walls’ throats; and
1d. longitudinal and oppositely longitudinal “C” braces, each “C” brace having an upper arm, a lower arm, a vertical bar spanning between proximal ends of said arms, and a forwardly opening throat, wherein the longitudinal and oppositely longitudinal “C” braces are respectively fixedly attached to the longitudinal and oppositely longitudinal “C” walls.

2. The conveyor tunnel oven of claim 1, wherein at least one of the longitudinal “C” brace’s arms is pivotally mounted, wherein at least one of the oppositely longitudinal “C” brace’s arms is pivotally mounted, and further comprising means for alternatively widening and narrowing the forwardly opening throats, said means being connected operatively to the “C” braces.

3. The conveyor tunnel oven of claim 2, wherein the means for alternatively widening and narrowing the forwardly opening throats comprise a plurality of linear motion actuators, wherein each linear motion actuator has a proximal end mounted upon one of the “C” braces’ bars, and wherein an opposite end of said each linear motion actuator is mounted upon one of the “C” braces’ arms.

4. The conveyor tunnel oven of claim 3, wherein each linear motion actuator comprises a rotatable cam.

5. The conveyor tunnel oven of claim 4, further comprising levers fixedly attached to the rotatable cams.

6. The conveyor tunnel oven of claim 5, wherein each lever has a levering end, and further comprising jack screws connected operatively to the levering ends of the levers.

7. The conveyor tunnel oven of claim 6 further comprising turning means connected operatively to the jack screws, the turning means being positioned at the baking case’s rear wall.

8. The conveyor tunnel oven of claim 1 wherein each wall among the longitudinal and oppositely longitudinal “C” walls has hollow interior, and wherein the longitudinal and oppositely longitudinal “C” braces are respectively housed within said hollow interiors.

9. The conveyor tunnel oven of claim 8, wherein each arm among the “C” braces’ upper and lower arms has a proximal end pivotally mounted upon one of the “C” braces’ bars, and further comprising splaying means connected operatively to said upper and lower arms, wherein the splaying means are adapted for alternatively moving distal ends of said upper and lower arms toward and away from each other.

10. The conveyor tunnel oven of claim 9, wherein the splaying means comprise lever actuated cams.

11. The conveyor tunnel oven of claim 10, wherein each lever actuated cam comprises a lever having a levered end and a levering end, and further comprising jack screws connected to the levers’ levering ends.

12. The conveyor tunnel oven of claim 11 wherein each jack screw comprises a rearwardly extending shaft, and further comprising turning means connected operatively to rearward ends of said shafts.

13. The conveyor tunnel oven of claim 12, wherein the turning means comprise shaft heads, wherein each shaft head is positioned at the baking case’s rear wall.

14. The conveyor tunnel oven of claim 11, wherein each lever actuated cam is circular, wherein said each cam has an off-center rotation axis, and wherein said each cam has an excentric end positioned oppositely from its off-center rotation axis.

15. The conveyor tunnel oven of claim 14, wherein each circular cam is adapted for rotation between a brace arm splaying position and a brace arm contracting position, wherein, upon the cams’ rotations to their brace arm splaying positions, the cams’ excentric ends extend forwardly, and wherein, upon the cams’ rotations to their brace arm contracting positions, the cams’ excentric ends move circumferentially away from their brace arm splaying positions.
